(19) United States
(12) Patent Application Publication
(10) Pub. No.: US 2026/0133793 A1
(43) Pub. Date: May 14, 2026

(54) SYSTEMS AND METHODS FOR DECOMMISSIONING APPLICATIONS IN AN ELECTRONIC ENVIRONMENT

(71) Applicant: BANK OF AMERICA CORPORATION, CHARLOTTE, NC (US)

(72) Inventors: Mohammad Saleem Gaziani, Plano, TX (US); Asha Thekkumpurath, Frisco, TX (US); Aravind Singtalur, McKinney, TX (US); John Andres Lozes, Wilmington, DE (US); Tonya Kyra Miller, Charlotte, NC (US); Amer Ali, Jersey City, NJ (US); Aaron Gee, Palm Coast, FL (US); Andrea M. Weisberger, Jacksonville, FL (US); Aisha Jenkins, Atlanta, GA (US); Manonmani Palanichamy, Fort Mill, SC (US)

(73) Assignee: BANK OF AMERICA CORPORATION, CHARLOTTE, NC (US)

(21) Appl. No.: 18/941,975

(22) Filed: Nov. 8, 2024

(51) Int. Cl. G06F 8/71

(52) U.S. Cl. CPC G06F 8/71

(57) ABSTRACT

Systems, computer program products, and methods are described herein for decommissioning applications in an electronic environment. The present disclosure is configured to identify an application identifier associated with an application in a network environment; collect, from an application repository, current application data associated with the application identifier; generate, based on the current application data, an application decommission interface component; configure a GUI of a user device with the application decommission interface component; collect, from the user device associated with the application, an application decommission indicator; update the application decommission interface component and the graphical user interface based on the application decommission indicator, wherein the updated application decommission interface component comprises a plurality of decommission requirement indicators; and decommission, in an instance where each of the plurality of decommission requirement indicators have been met, the application in the network environment based on the application decommission indicator and the current application data.

### TECHNOLOGICAL FIELD

Example embodiments of the present disclosure relate to decommissioning applications in an electronic environment.

### BACKGROUND

In network environments with many applications still in use and many applications that need to be efficiently and dynamically retired, the process for decommissioning the proper applications can be a complex process. For instance, the challenges with decommissioning an application may comprise difficulties with data migration between applications to new platforms or storage components can be difficult and time-consuming, meeting difference retention requirements for application data and application software can be difficult to determine and carry out, network security threats are heightened as obsolete applications can run outdated software that could pose threats to network and information security, the time consumed in retiring applications can be extensive and can be prolonged when manual intervention is required, and communication and coordination between different decommission teams is critical, but can be difficult to maintain. Thus, a great need exists for a system that can decommission applications in an electronic environment in an automatic, secure, and dynamic manner, whereby the processes to decommission these applications may be application and/or user specific, and the system may need to dynamically change its process depending on these specific guidelines.

Applicant has identified a number of deficiencies and problems associated with decommissioning applications in an electronic environment. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for decommissioning applications in an electronic environment.

In one aspect, a system for decommissioning applications in an electronic environment is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify an application identifier associated with an application in a network environment; collect, from an application repository, current application data associated with the application identifier; generate, based on the current application data, an application decommission interface component; configure a graphical user interface of a user device with the application decommission interface component, wherein the user device is associated with the application; collect, from the user device associated with the application, an application decommission indicator, wherein the application decommission indicator comprises a decommission date for the application; update the application decommission interface component and the graphical user interface configured with the updated application decommission interface component based on the application decommission indicator, wherein the updated application decommission interface component comprises a plurality of decommission requirement indicators; and decommission, in an instance where each of the plurality of decommission requirement indicators have been met, the application in the network environment based on the application decommission indicator and the current application data.

In some embodiments, a decommission status for the application is updated in response to the identification of the application identifier; and wherein the updated decommission status comprises a projected decommission indicator for the application identifier.

In some embodiments, executing the computer-readable code is further configured to cause the at least one processing device to: transmit a decommission request to the user device associated with the application; receive, in response to the transmission of the decommission request, an approval of the decommission request; and update, in response to the approval, the application decommission indicator.

In some embodiments, the application decommission indicator comprises at least one of a retire request or a retire and retain data only request. In some embodiments, the current application data comprises at least one of current usage data and the application decommission indicator comprises the retire request, and wherein executing the computer-readable code is further configured to cause the at least one processing device to: determine, based on the current application data, the current usage data comprises a zero usage indicator for the at least one application; determine, based on the updated application decommission interface component, the application has met each decommission requirement of the application decommission interface component; and decommission, in an instance where each of the plurality of decommission requirement indicators have been met, the application in the network environment based on the application decommission indicator and the current application data. In some embodiments, the determination of the current usage data is continuously determined until the current usage data comprises the zero usage indicator.

In some embodiments, the application decommission indicator comprises the retire and retain data only request, and wherein executing the computer-readable code is further configured to cause the at least one processing device to: identify a retain period for the application; determine, based on the current application data, the current usage data comprises a zero usage indicator for the at least one application; determine, based on the application, at least one retention requirement of application data from the application; automatically store at least a portion of the application data based on the at least one retention requirement and the retain period; and decommission, in response to the retain period being met and the at least one retention requirement being met by the automatic storage of at least the portion of the application data, the application.

In some embodiments, the application decommission indicator comprises a retain application and data request. In some embodiments, executing the computer-readable code is further configured to cause the at least one processing device to: identify a retain period for the application; determine, based on the application, at least one retention requirement of application data from the application; identify, based on the at least one retention requirement, at least one user identifier that is allowed access to the application at a future time after the decommission of the application, wherein the decommission of the application is a partial decommission; configure the application for inquiry only; and decommission, in response to the retain period being met, the configured application as a partial decommission.

In some embodiments, the decommission of the application comprises a predefined decommission period between the collection of the application decommission indicator and the decommission of the application.

In some embodiments, the application repository comprises a plurality of application data sources. In some embodiments, the application decommission interface component and the updated application decommission interface component comprises a plurality of hyperlinks to the plurality of application data sources.

In some embodiments, the decommission of the application comprises a full or partial decommission.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for decommissioning applications in an electronic environment, in accordance with an embodiment of the disclosure;

FIG. 2 illustrates a process flow for decommissioning applications in an electronic environment, in accordance with an embodiment of the disclosure;

FIG. 3 illustrates a process flow for updating the application decommission indicators, in accordance with an embodiment of the disclosure;

FIG. 4 illustrates a process flow for decommissioning an application based on a plurality of decommission requirements being mete, in accordance with an embodiment of the disclosure;

FIG. 5 illustrates a process flow for decommissioning an application and retaining application data, in accordance with an embodiment of the disclosure;

FIG. 6 illustrates a process flow for partially decommissioning an application and retaining application data, in accordance with an embodiment of the disclosure; and

FIG. 7 illustrates a process for decommissioning applications in an electronic environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In network environments with many applications still in use and many applications that need to be efficiently and dynamically retired, the process for decommissioning the proper applications can be a complex process. For instance, the challenges with decommissioning an application may comprise difficulties with data migration between applications to new platforms or storage components can be difficult and time-consuming, meeting difference retention requirements for application data and application software can be difficult to determine and carry out, network security threats are heightened as obsolete applications can run outdated software that could pose threats to network and information security, the time consumed in retiring applications can be extensive and can be prolonged when manual intervention is required, and communication and coordination between different decommission teams is critical, but can be difficult to maintain. Thus, a great need exists for a system that can decommission applications in an electronic environment in an automatic, secure, and dynamic manner, whereby the processes to decommission these applications may be application and/or user specific, and the system may need to dynamically change its process depending on these specific guidelines.

Thus, the disclosure provided herein includes the identification of an application identifier associated with an application in a network environment; the collection, from an application repository, of current application data associated with the application identifier; the generation, based on the current application data, of an application decommission interface component; the configuration of a graphical user interface of a user device with the application decommission interface component, wherein the user device is associated with the application; and collection, from the user device associated with the application, of an application decommission indicator, wherein the application decommission indicator comprises a decommission date for the application. Further, the disclosure provides for the updating of the application decommission interface component and the graphical user interface configured with the updated application decommission interface component based on the application decommission indicator, wherein the updated application decommission interface component comprises a plurality of decommission requirement indicators; and the decommission, in an instance where each of the plurality of decommission requirement indicators have been met, of the application in the network environment based on the application decommission indicator and the current application data.

In other words, the disclosure provides a system for decommissioning applications using a site (e.g., an application decommission interface/updated application decommission interface component that is used to configure a user device's GUI) that navigates through the stages of decommissioning each application. In this manner, the site may automatically move to the next stage or next few stages of the application life cycle based on the deliverables that have already been completed (e.g., the application decommission requirements shown as application decommission requirement indicators). Additionally, the site may be configured to integrate with data and application repositories that can pull the current data about each application, and update the site with current information regarding the application (e.g., firewall rules list, pending database expenses, vendor information and licensing information, server runbook for infrastructure tasks, decommission requirements that have been met and still need to be met, and/or the like).

What is more, the present disclosure provides a technical solution to a technical problem. As described herein, the technical problem includes of decommissioning applications in a network environment in a streamlined and standardized manner. The technical solution presented herein allows for the decommissioning of applications in an electronic environment by generated and updating an application decommission interface component, which may be used to configure a user device GUI, to show each of the requirements for each decommission process in an application-specific manner, and which further allows for a standardized and streamlined method of decommissioning different applications across different platforms, systems, user devices, and/or the like. In particular, the disclosure provided herein is an improvement over existing solutions to the process of decommissioning applications, (i) with fewer steps to achieve the solution, thus reducing the amount of computing resources, such as processing resources, storage resources, network resources, and/or the like, that are being used (e.g., by automatically collecting application data from an application repository and automatically generating and updating an application decommission interface component configured on a user device's GUI to show a user the decommission requirements that have been met and which need to be met); (ii) providing a more accurate solution to problem, thus reducing the number of resources required to remedy any errors made due to a less accurate solution (by updating the application decommission interface component in real time or near real time with the most up-to-date information); (iii) removing manual input and waste from the implementation of the solution, thus improving speed and efficiency of the process and conserving computing resources (e.g., by allowing for the automatic collection of application data from the application repository, by automatically decommissioning the application upon meeting each of the decommission requirements specific for the application); and (iv) determining an optimal amount of resources that need to be used to implement the solution, thus reducing network traffic and load on existing computing resources (by accessing a singular application repository to collect application data, network traffic is reduced, especially compared to traditional methods which may have required manual intervention and manual collection of this data from multiple decommission or information technology teams for each requirement to be met). Furthermore, the technical solution described herein uses a rigorous, computerized process to perform specific tasks and/or activities that were not previously performed. In specific implementations, the technical solution bypasses a series of steps previously implemented, thus further conserving computing resources.

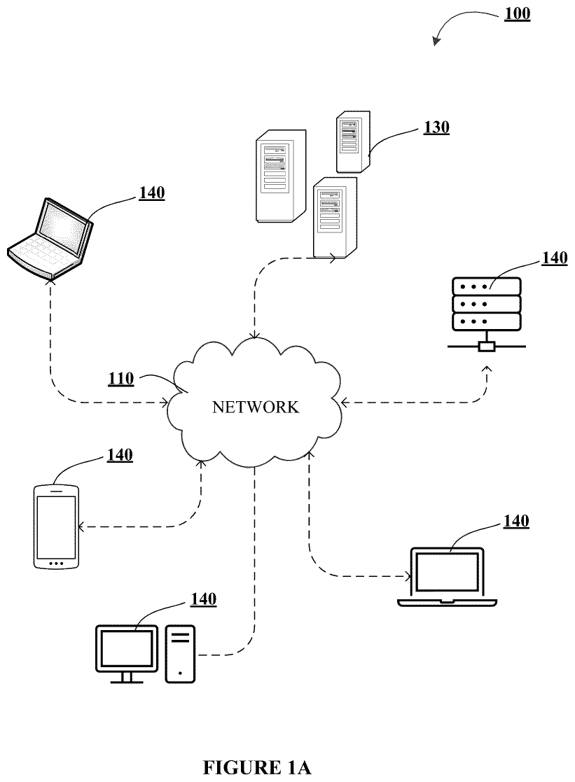

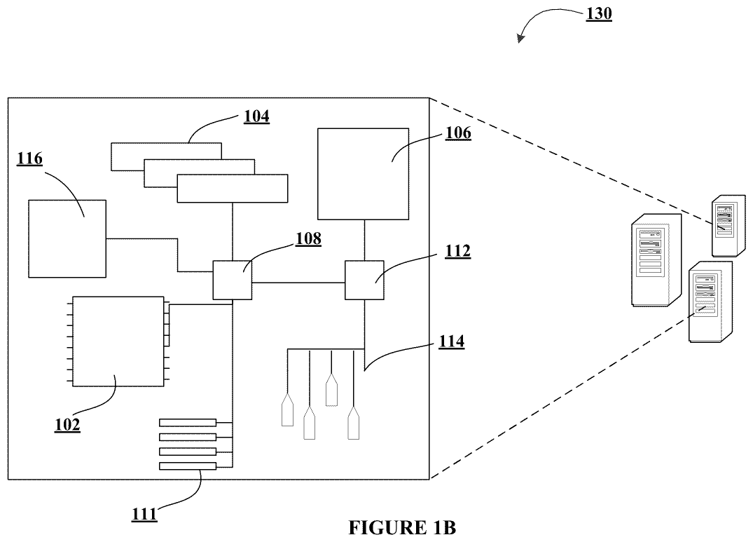

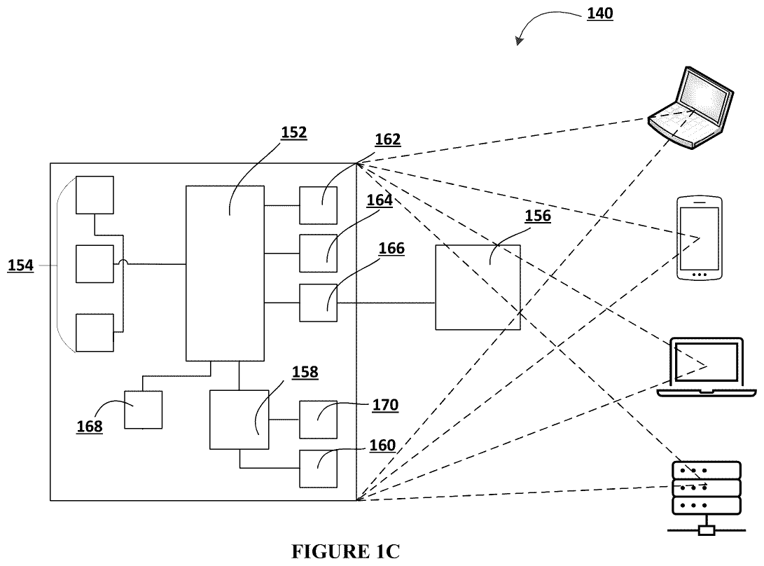

FIGS. 1A-1C illustrate technical components of an exemplary distributed computing environment for decommissioning applications in an electronic environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

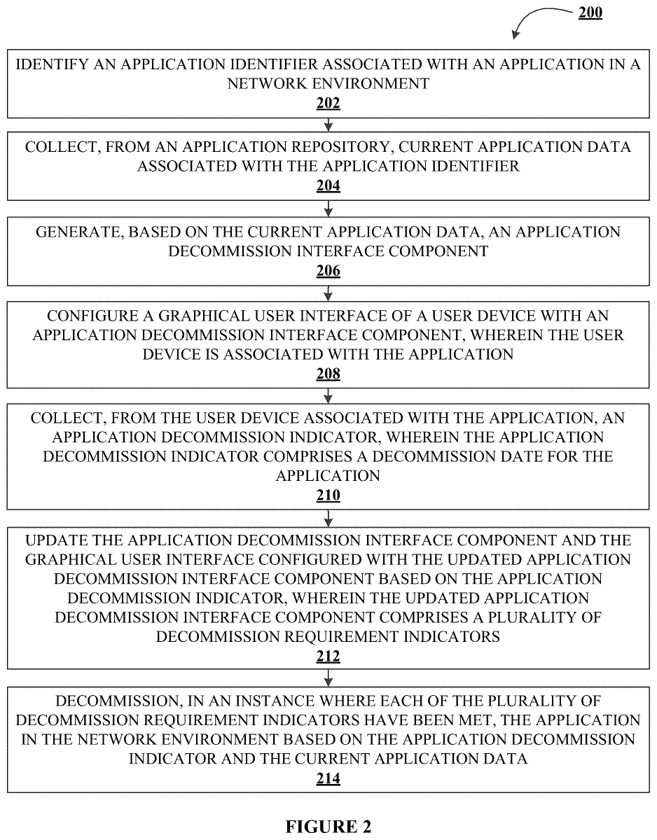

FIG. 2 illustrates a process flow 200 for decommissioning applications in an electronic environment, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As show in block 202, the process flow 200 may include the step of identifying an application identifier associated with an application in a network environment. For instance, the system may identify an application identifier associated with an application by receiving the application identifier from a user device associated with the application. By way of non-limiting example, such a user device may be controlled and/or operated by a user that has access to decommission an application. Such an access to decommission the application may be based on their security clearance within the network comprising the application, based on their security clearance for the specific application, based on their security clearance of an entity managing the application and/or using the application within their network, and/or the like. In some embodiments, the system itself may identify the application identifier based on determining an application has hit its expiration date in the network, where such an expiration date may be pre-determined by the owner of the application, the operator or manager of the application (e.g., a user or entity using the application), and/or the like.

As used herein, such an application identifier may uniquely identify the application within the associated network, on a particular user device, on a plurality of user devices associated with the network, and/or the like. Thus, and based on the application identifier, the system may identify an application within a network that is requested to be decommissioned.

In some embodiments, a decommission status for the application is updated in response to the identification of the application identifier, and wherein the updated decommission status comprises a projected decommission indicator for the application identifier. For example, and in some such embodiments, the system may update a current status of the application to a decommission status, which indicates to the system and to the users that can access the system (such as through a user device with a configured graphical user interface indicating the application data and current application status/decommission status of the application) that the application is undergoing a decommission process. For instance, and in some embodiments, the decommission process may comprise a “Projected Retire” status, which may indicate that the application is getting ready to start the decommission process, but first must undergo certain steps before the application can start a full decommission or partial decommission process. By way of non-limiting example, the projected retire status may comprise a completion of an owner or operator of the application approving the full or partial retirement for the application (such as by an indication received from a user device), a decommission date, a manual decommission request (or disposition request) that has been submitted to a pre-determined user (such as an owner-user of the application that has clearance to decommission the application), and/or the like. In some embodiments, and upon these steps with in the projected retire status, the system may receive an application decommission indicator from a user device (e.g., the same owner-user as described above, the same user that generated the application identifier, and/or the like), which is described in further detail herein.

As shown in block 204, the process flow 200 may include the step of collecting, from an application repository, current application data associated with the application identifier. For example, the system may access an application repository or application database which is configured as an application storage component that stores application data for each application in the associated network. In some embodiments, the application repository or database may comprise current application data (such as current usage data for each application in an associated network, a current decommission status, current data used for meeting or completing steps in the decommission process, and/or the like). Thus, and in some embodiments, the application repository may comprise all the data associated with an application, including but not limited to application data needed to decommission the application, data that may need to be retained even after the application is decommissioned, and/or the like.

Thus, and in some embodiments, the system may access the application repository through a network, such as the network shown in FIG. 1A, which may store or comprise the application repository and the applications associated with the application repository. In some embodiments, the application repository may collect application data directly from the applications, from systems or system components associated with the application, from user devices interacting with the applications, and/or the like. In other words, the application repository comprises a plurality of application data sources. For example, the application repository may comprise application data that was collected from a plurality of application data sources, such as but not limited to user devices accessing and/or interacting with the applications, application databases that collected the application data for each application manager or operator, from the applications themselves, from the servers and/or networks hosting the applications, and/or the like. Thus, the application repository may—in some embodiments—collect all the data associated with each application, and organize the application data in such a manner that the application data can be easily and quickly accessed and collected by the system (e.g., such as an organization based on the application identifier).

As shown in block 206, the process flow 200 may include the step of generating, based on the current application data, an application decommission interface component. For example, the system may generate an application decommission interface component which is generated as a data packet that can configure a graphical user interface (GUI) of a user device to show the underlying data of the application decommission interface component on the GUI. For instance, the system may generate the application decommission interface component with data the system would like to display on the recipient user device's GUI, such as but not limited to the current application data collected in block 204. Thus, and in some such embodiments, the system may automatically generate the application decommission interface component with the current application data of the application associated with the application identifier, and such current application data may comprise the current usage data of the application (e.g., how many users have recently accessed the application, which users have recently accessed the application, which user devices have accessed the application recently, what data has been collected for and/or from the application, and/or the like). In some embodiments, the application decommission interface component may comprise any of the data described herein with respect to the associated application, only a portion of the data described herein, and/or the like.

In some embodiments, the application decommission interface component may further comprise a request for a user associated with the recipient user device to input an application decommission indicator (e.g., a request for the application to be fully retired, for the application to be partially retired and its data to be retained, for the application data to be retained and the application be retired). Thus, and in some embodiments, the system may configure the GUI of the recipient user device to request the user a request for the application be fully retired, partially retired, the application data to be retained, and/or the like, and based on this request, the system may update the application decommission interface component with decommission requirements that are specific to each request for the application. Such an embodiment is described in further detail below.

In some such embodiments, the system may determine the recipient user device to receive the application decommission interface component based on identifying which user accounts and their associated user devices have the security clearance to decide what should happen to the application (e.g., the security clearance to retire the application fully or partially). In some embodiments, the system may identify the user account(s) that have the security clearance to decide the application should be retired fully or partially based on accessing the application repository, which may store such user account identifiers with the proper security clearance. In some embodiments, the system may access the application itself to identify the user account(s) identifiers that can make updates to the application network-wide, whereby such a user account identifier(s) may be stored within the metadata of the application on the network. Thus, and based on the user account identifier(s) identified by the system, the system may transmit the application decommission interface component to the user device(s) associated with the user account identifier(s), such that the application decommission interface component automatically configures the GUI(s) of the user device(s) to show the data of the application decommission interface component. In some embodiments, and where a plurality of user account identifiers are identified, the system may transmit the application decommission interface component to only one user device associated with one of the user account identifiers and only one user account of the plurality of user account identifiers may need to be submit their application decommission indicator. In some embodiments, the application may require that all of the user accounts associated with the plurality of user account identifiers identified must submit an application decommission indicator, and thus all of the user devices associated with all of the user account identifiers may be configured with the application decommission interface component, and only in an instance where a majority of the application decommission indicators match or all of the application decommission indicators from all the user devices match, will the majority or all of the application decommission indicators be accepted by the system.

In some embodiments, the application decommission interface component and the updated application decommission interface component comprises a plurality of hyperlinks to the plurality of application data sources. Thus, and in some embodiments, the current application data of the application decommission interface component may be indicated by a plurality of hyperlinks, which may be a digital reference to data that is stored in the application repository and/or in another data source. Thus, and by the application decommission interface component comprising a plurality of hyperlinks, the application decommission interface component may reduce its stored data, which may in turn increase network transmission speed of the application decommission interface component, processing speed of generating the application decommission interface component, storage resources for storing the application decommission interface component, and/or the like.

As shown in block 208, the process flow 200 may include the step of configuring a graphical user interface (GUI) of a user device with an application decommission interface component, wherein the user device is associated with the application. For instance, the system may trigger a configuration of the GUI of the recipient user device upon transmitting the application decommission interface component to the recipient user device. In some embodiments, application decommission interface component configured on the GUI of the user device may comprise a pop-up notification, which may pop-up in real time or near real time to the recipient user device receiving the application decommission interface component. Thus, and in some embodiments, the recipient user device that receives the application decommission interface component may be associated with a user account identifier that has the clearance (e.g., security clearance) to determine what will be done with the application on the network, such as but not limited to whether the application should continue running in the network, should be retired in the network, should be partially retired in the network, whether the application data should be retained in the network, and/or the like. Thus, and in some embodiments, the system may determine which user device(s) should receive the application decommission interface component to configure the recipient user device(s') GUI(s).

As shown in block 210, the process flow 200 may include the step of collecting, from the user device associated with the application, an application decommission indicator, wherein the application decommission indicator comprises a decommission date for the application. For example, the system may collect an application decommission indicator from the user device(s) that are configured with the application decommission interface component, whereby the application decommission indicator may indicate what should happen to the application associated with the application identifier that the application decommission interface component was based on. Thus, and in some embodiments, the application decommission indicator may comprise a user input or command indicating that the application should be fully retired (and no application data will be retained), that the application should be partially retired (but may still remain available to pre-determined user accounts) and application data will be retained, that the application should be fully retired and application data be retained, and/or the like. In some embodiments, the GUI of the user device configured with the application decommission interface component may comprise user input interface components that each comprise the optional application decommission indicators, such that the user of the user device may select or “click” on the optional application decommission indicator they want.

Thus, and in some embodiments, the system may collect—by receiving the application decommission indicator—from the user device configured with the application decommission interface component. In some embodiments, the application decommission indicator may comprise a decommission date for the application, which may be determined by the user of the user device and may indicate the date that the application should be decommissioned by (fully, partially, and/or the like). In some embodiments, the decommission date may be determined by the system based on the date the application decommission indicator was received. For example, and in some embodiments, the decommission date may be 120 days from the date the application decommission indicator was received.

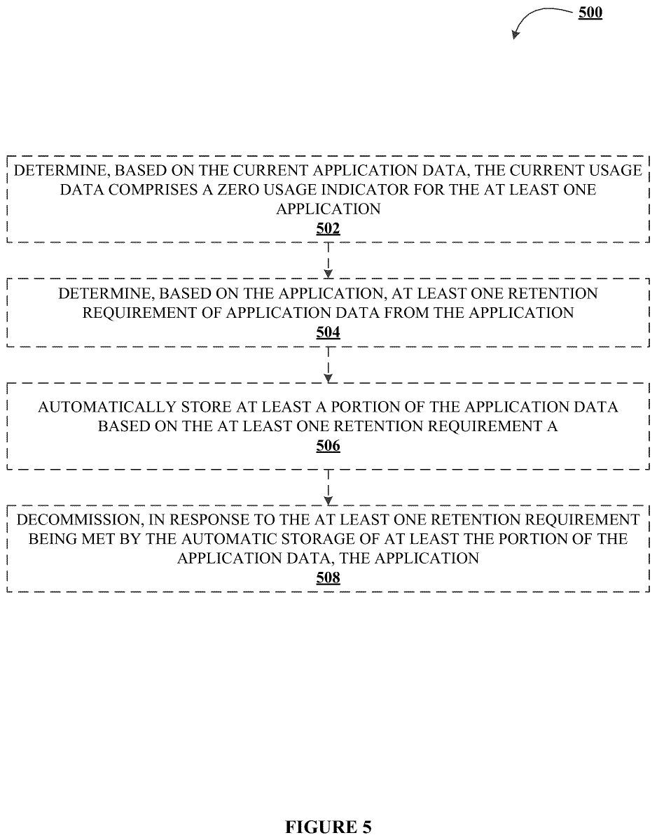

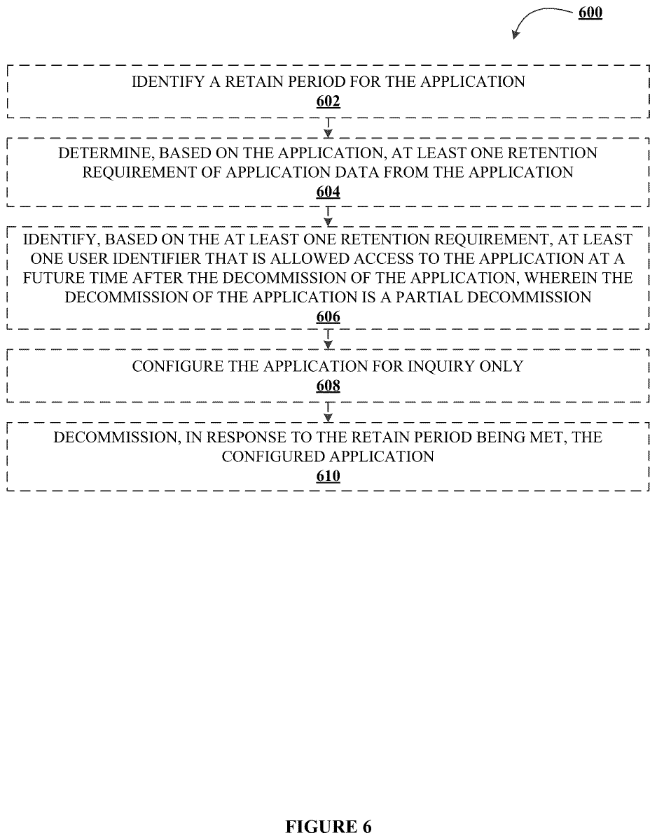

In some embodiments, the application decommission indicator comprises at least one of a retire request (e.g., a full retire request for the application) or a retire and retain data only request (e.g., a full retire and retain data for or from the application request). Such an embodiment is described in further detail below with respect to FIG. 5. In some embodiments, the application decommission indicator comprises a retain application and data request (e.g., a partial retire application and retain data request). Such an embodiment is described in further detail below with respect to FIG. 6.

As shown in block 212, the process flow 200 may include the step of updating the application decommission interface component and the graphical user interface (GUI) configured with the updated application decommission interface component based on the application decommission indicator, wherein the updated application decommission interface component comprises a plurality of decommission requirement indicators. For example, the system may update the application decommission interface component to show all the requirements to complete decommission process associated with the application decommission indicator. For instance, the steps and/or process to decommission the application in accordance with the application decommission indicator may change based on the application decommission indicator received. Thus, and based on the application decommission indicator, the application decommission interface component may be changed to comprise all the steps needed to decommission the application, and each step may be configured with a complete status or an incompletion status depending on which steps have already been completed and which still need to be completed. Therefore, the updated application decommission interface component may comprise the current status of the decommission process for the application, including all the steps that have been completed, their application data which may have been used to complete the step in the process, the steps that have not yet been completed, and/or the like. In other words, the updated application decommission interface component may show each of the requirements to decommission the application as decommission requirement indicators, which may be configured on the GUI of the recipient user device when the updated application decommission interface component is transmitted to the user device.

By way of non-limiting example, a step in the process for fully decommissioning an application may comprise the system determining that there has been no usage activity on the application (by users or user devices) for a pre-determined time (such as within the past 24 hours, past week, past two weeks, past month, and/or the like). Similarly, a step in the process for fully decommissioning the application and retaining the data may also comprise the system determining that there has been no usage activity on the application for the pre-determined time. In contrast, and where the application is only being partially decommissioned (only for most users, while a specified subset of users may still access the application and/or only query within the application), the system may need to determine that the application is still in limited production, with only the pre-defined users (specified users that are determined as allowable to use the application after decommission) over the pre-determined time.

As shown in block 214, the process flow 200 may include the step of decommissioning, in an instance where each of the plurality of decommission requirement indicators have been met, the application in the network environment based on the application decommission indicator and the current application data. For example, the system may decommission the application, fully or partially with the network environments, in an instance where all the decommission requirement requirements have been met (which may be indicated in the decommission requirement indicators on the updated application decommission interface component). In some such embodiments, the system may continuously update the application decommission interface component regularly with the current application data, such that the updated application decommission interface component shows the up-to-date data of the application, including the current decommission requirements that have been met, which decommission requirements have not been met, and what all the decommission requirements are for the decommission requirement.

In some embodiments, the decommission of the application comprises a predefined decommission period between the collection of the application decommission indicator and the decommission of the application. For instance, such a predefined decommission period may comprise a predetermined threshold time (such as 120 days from the time the system receives the application decommission indicator), which may be received from a user device associated with the application (such as a user device that generated and transmitted the application decommission indicator). In some embodiments, the predefined decommission period may be predetermined by the system itself, such as in an instance where the system is based its predefined decommission period on a standard in the network, a standard for the applications in the network, a standard for system, a standard for the entity operating or using the application, and/or the like.

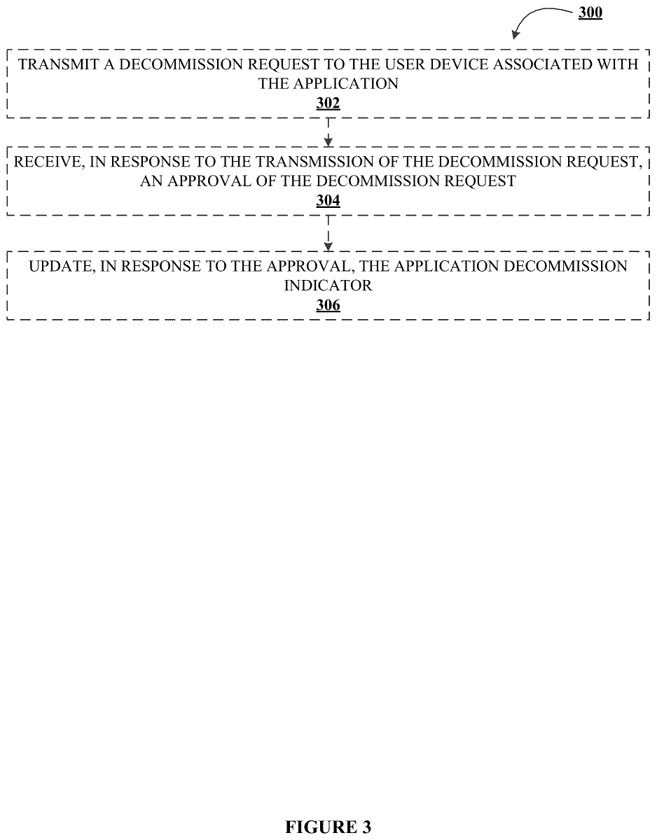

FIG. 3 illustrates a process flow 300 for updating the application decommission indicators, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of transmitting a decommission request to the user device associated with the application. In some such embodiments, and upon receiving the application decommission indicator(s) from the user device(s), the system may identify the application decommission indicator(s) as an approval(s) of the decommission request. For instance, and in some embodiments, the system may transmit the decommission request to the user device associated with a user account that has the clearance to decide what to do with the application, whether the application should be fully retired, partially retired, the application data be retained, and/or the like. In some embodiments, the system may transmit the decommission request to a plurality of user devices associated with the application. For example, the plurality of user devices may each be associated with a user account that is required to agree to decommissioning the application before the process for decommissioning the application can begin. Thus, and in such embodiments, the system may identify all the user accounts that are required to agree to decommission the application, and the system may automatically transmit the decommission request to each user device associated with each required user account, and may wait to start the decommission process until all the application decommission indicators comprising the same application decommission indicator type have been received.

In some embodiments, and where the network, the system, and/or an entity associated with the application may require a minimum number of required user accounts to approve the decommission process for an application. Thus, and in such an embodiment, the system may identify the user accounts that comprise the clearance to decommission the application, and based on this identification, the system may automatically transmit the decommission request to each user device associated with each identified user account. In some such embodiments, and upon receiving a plurality of application decommission indicators that comprise the same application decommission indicator type (full retire, partial retire, retain data, and/or the like), the system may determine the plurality of application decommission indicators of the same type meet the minimum number required for the application decommission process to begin.

In some embodiments, and as shown in block 304, the process flow 300 may include the step of receiving, in response to the transmission of the decommission request, an approval of the decommission request. For instance, the system may receive an approval of the decommission request as an application decommission indicator. In such an instance where the approval is received via the application decommission indicator, the system may update the application decommission indicator on the updated application decommission interface component to show the requested decommission process and the decommission requirements to complete the decommission process for the application.

In some embodiments, and as shown in block 306, the process flow 300 may include the step of updating, in response to the approval, the application decommission indicator. Thus, and by way of example, the processes described herein may comprise a manual disposition of the application request that is submitted to a required user device (such as a user device associated with a legal user account within an entity that owns or operates the application), and approval from such a user device may be required before the system can change the application status from a “Projected Retire” status to a “retire” status (partial or full) or “retain” status (retain data).

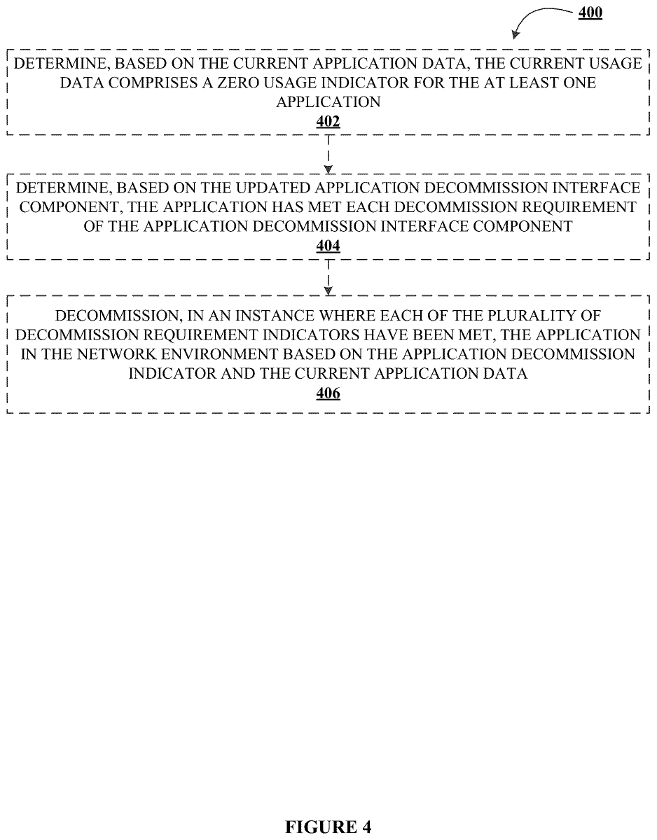

FIG. 4 illustrates a process flow 400 for decommissioning an application based on a plurality of decommission requirements being mete, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of determining, based on the current application data, the current usage data comprises a zero usage indicator for the at least one application. For example, and in some embodiments, the system may update the required process to a retire process based on a retire request being received as the application decommission indicator described above. Thus, such a process as that described herein with respect to process flow 400 may occur in an instance where the application decommission indicator comprises a retire request and, where the current application data comprises at least one of current usage data and the application decommission indicator comprises the retire request. Thus, and in some such embodiments, the system may determine that the current usage of the application (such as within a recent period of the immediate 8 hours, 16 hours, 24 hours, week, month, and/or the like) is zero, which indicates that the application is not currently being used or accessed by any users, user devices, user accounts, system components, network components, and/or the like. Thus, and in order to fully retire the application, the system must first determine that the current usage data of the application comprises a zero usage indicator.

In some embodiments, the system may continuously determine the current usage data until the current usage data comprises the zero usage indicator. Thus, and in some embodiments, the system may continuously access the usage data for the application (such as by accessing the application repository which may comprise the usage data for each application in the network) until the system can determine the current usage data comprises a zero usage indicator. In some embodiments, such an application repository may be updated continuously and in real time or near real time to each change in the underlying application and its application data. In some embodiments, the application repository may be updated at pre-defined intervals (such as every five or six seconds, every ten seconds, every thirty seconds, every minute, ever five minutes, every six minutes, every ten minutes, every fifteen minutes, every thirty minutes, every hour, and/or the like), and the system may access the application repository at an instance in real time or near real time after the update to the application repository to determine the current usage data for the application, until the current usage data is determined to be zero.

In some embodiments, and as shown in block 404, the process flow 400 may include the step of determining, based on the updated application decommission interface component, the application has met each decommission requirement of the application decommission interface component. For instance, the system may determine the application has met at least one decommission requirement to fully decommission the application when the current usage data is determined to be zero. In some embodiments, additional decommission requirements may be required for the decommission process to be completed for the application. However, and in some embodiments, the system may determine that the only requirement to fully retire the application and not retain any application data is for the current usage data to comprise the zero usage indicator. In some such embodiments, the system may require the current usage data to comprise the zero usage indicator for a continuous predefined threshold time, which may be predefined by the system, by a manager or operator of the application, by the application, by at least one user device or user account associated with the application, and/or the like. In some embodiments, the system may determine that the zero usage indicator is present for the continuous predefined threshold time, and thus, the application can be fully decommissioned in real time or near real time to the meeting of the continuous predefined threshold time.

In some embodiments, the system may determine a plurality of decommission requirements are present for the decommission process and are shown in the updated application decommission interface component. Thus, and in some such embodiments, the system may identify all the decommission requirements that are needed for the application to be fully retired. Such decommission requirements may be indicated in the application decommission interface component.

In some embodiments, and as shown in bock 406, the process flow 400 may include the step of decommissioning, in an instance where each of the plurality of decommission requirement indicators have been met, the application in the network environment based on the application decommission indicator and the current application data. For instance, and in some such embodiments, the system may automatically decommission the application fully in an instance where each of the decommission requirements of the decommission requirement indicators have been completed or met (including but not limited to the current usage data comprising a zero usage indicator). Thus, and upon the system determining that the plurality of decommission requirement indicators have been met, the system may automatically fully decommission the application in the network environment.

FIG. 5 illustrates a process flow 500 for decommissioning an application and retaining application data, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 504, the process flow 500 may include the step of determining, based on the current application data, the current usage data comprises a zero usage indicator for the at least one application. For example, and in some such embodiments, the system may determine that the current usage data comprises a zero usage indicator in the same or similar manner as the method for determining the current usage data in FIG. 4. In some embodiments, the step of determining the current usage data comprises a zero usage indicator may occur in an instance after the application decommission indicator has been determined to comprise a retire and retain data only request. In some embodiments, such a process as that described herein with respect to process flow 400 may occur in an instance where the application decommission indicator comprises a retire and retain data only request.

In some embodiments, and as shown in block 506, the process flow 500 may include the step of determining, based on the application, at least one retention requirement of application data from the application. For instance, and in some embodiments, the system may determine at least one retention requirement for the application data, such as a regulatory, compliance, retain period requirement, and/or the like for retaining application software and/or data after the application has been fully and/or partially retired.

For example, and in some such embodiments, the system may identify a retain period requirement for the application data based on the system identifying a standard retain period for application data in the network environment, by the system accessing a retain period requirement in the application metadata (which may occur when the application is downloaded in the network and a retain period requirement is generated for the case where the application will be fully or partially retired and the application data will be retained), by the system receiving the retain period requirement as a user input from a user device associated with the system (such as from a user device associated with a manager of the system, a manager or operator of the application, and/or the like), and/or the like. As used herein, the retain period requirement may refer to a period for the data of an application that is being retired (fully and/or partially) to be retained. In some embodiments, the retain period requirement may comprise an indefinite period, which may be the case for important data that must always be retained and stored. In some embodiments, the retain period requirement may comprise a specified period that may be re-enrolled based on receiving an acceptance indicator from a user device associated with the application which indicates that the application data should be retained for at least another additional specified period.

In some embodiments, the compliance and/or regulatory requirement(s) may be generated by an outside entity for the application, and the system may collect these compliance and/or regulatory requirements from a database, an online source, and/or the like. In some embodiments, the system may comprise a web crawler to access and parse data online to determine the compliance and/or regulatory requirements for specific applications, specific types of applications, and/or the like. Based on these retention requirements, the system may automatically store the application data and/or software from the application in accordance with the retention requirements. Further, and in some such embodiments, the data and/or software retained by the system may be determined by the retention requirements determined by the system.

In some embodiments, and as shown in block 508, the process flow 500 may include the step of automatically storing at least a portion of the application data based on the at least one retention requirement. For instance, and in some such embodiments, the system may automatically store at least a portion of the application data and/or a portion of the application software in accordance with the at least one retention requirement. For instance, and where the retention requirements comprise a retain period requirement and a regulatory requirement indicating a specific portion of user data that must be retained to comply with a regulatory requirement, then the system may automatically store the identified portion of user data from the application for at least the retain period identified in the retain period requirement.

In some embodiments, the application data and/or application software may be stored in its own separate database, which may further be protected by encryption, access control policies, immutable storage, and/or the like. In some such embodiments, the separate database may be generated solely for the storage of the application data and/or software retained by the system described herein.

In some embodiments, and as shown in block 510, the process flow 500 may include the step of decommissioning, in response to the at least one retention requirement being met by the automatic storage of at least the portion of the application data, the application. For instance, and in some such embodiments, the system may automatically decommission the application (fully and/or partially) once the system has determined that each and all of the retention requirement(s) have been met. In some embodiments, the system may decommission the application fully and/or partially, depending on the application decommission indicator that was received in previous steps (such as that shown in FIG. 2).

By way of non-limiting example, the process described herein with respect to FIG. 5 may occur when an application is no longer usable, and the application data or software of the application needs to be retained (such as for regulatory, compliance, or other requirements). For example, the system may store files for future online or offline access. In some embodiments, and upon meeting the retain period, the system may teardown and decommission the retained data and/or retained software. In such an embodiment, the previously retained data may remain secure and unavailable for future misuse or misappropriation.

FIG. 6 illustrates a process flow 600 for partially decommissioning an application and retaining application data, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

In some embodiments, and as shown in block 602, the process flow 600 may include the step of identifying a retain period for the application. For example, the system may identify a retain period for the application in a similar manner as the manner described above for the system to identify the retain period requirement for the application data. For instance, the retain period may be transmitted from a user device to the system (e.g., the user of the user device may have input the retain period for the application), identified from the application metadata, may be identified based on a standard application retain period for applications within the network environment, and/or the like.

In some embodiments, and as described herein, the process flow 600 may occur in an instance where the application decommission indicator comprises a retain application and data request. Thus, and by way of example, the retain application and data request may indicate that the application should be partially retired, and partially retained (for certain users and/or uses).

In some embodiments, and as shown in block 604, the process flow 600 may include the step of determining, based on the application, at least one retention requirement of application data from the application. For example, the system may determine the retention requirements for the application in the same or similar manner as the determination of the retention requirements in block 502 of FIG. 5. For instance, and in some such embodiments, the system may determine regulatory and/or compliance requirements for each application at issue, and based on these determinations, the system may identify the portions of the application (e.g., portions of application data and/or software) that may remain after the application has been partially decommissioned. In some embodiments, the retention requirements may further comprise user account identifiers that may continue to access the application after the partial decommission. Such an embodiment is described in further detail below.

In some embodiments, and as shown in block 606, the process flow 600 may include the step of identifying, based on the at least one retention requirement, at least one user identifier that is allowed access to the application at a future time after the decommission of the application, wherein the decommission of the application is a partial decommission. For instance, and in some embodiments, the system may identify—using at least one retention requirement—at least one user account identifier (i.e., user identifier) that is allowed to access the application at a future time. In some embodiments, the access allowed by the at least one user associated with the user identifier may only comprise an ability of the user to query the application only. In some embodiments, the at least one retention requirement may allow certain features and/or programs to be run within the application after the decision for the user accounts associated with the user identifiers.

Thus, and in some such embodiments, the partial decommission of an application refers to a partial retirement of the application such that only specific components, functionalities, application data, and/or the like are retired, while the core of the application may remain operational. Thus, and as used herein, the term decommission refers to the full or partial retirement of an application in its network environment. Thus, and upon decommissioning an application, a user within the network may no longer be able to access the application (and in some instances, the application data).

In some embodiments, and as shown in block 608, the process flow 600 may include the step of configuring the application for inquiry only. For instance, and in some embodiments, the system may configure the application based on the retention requirement(s), such that the application is configured to allow access to the at least one user associated with the user identifier identified in block 606 in the allowed manner. For instance, and where the at least one retention requirement comprises an inquiry only requirement, then the system may configure the application for inquiry only and allow only the user(s) associated with the allowed user identifier(s) to access the application for inquiry only. Thus, and as used herein, the configuration of the application to an inquiry only application may comprise the application being configured to allow only queries to be submitted, and no new data or modifications may be allowed within the application.

In some embodiments, and as shown in block 610, the process flow 600 may include the step of decommissioning, in response to the retain period being met, the configured application as the partial decommission. In some embodiments, the system may only partially decommission the application at the end of the retain period. In such an embodiment, the application may need to continuously be partially retained in order to allow further queries to occur and further collection application data to occur until all the necessary data (based on the retention requirement(s)) has been retained and stored. Further, and in some such embodiments, the system may decommission—once the retain period has been met at a current time (e.g., where the retain period is 120 days, and 120 days have passed since the application was partially decommission) and where the retention requirements have been met—the application fully.

Thus, and by way of example, the process described herein with respect to FIG. 6 may occur for an application that is being retained (partially) and its application data is being retained. In such an embodiment, the system may determine the regulatory, compliance, and any other requirements for retention are present for the software and/or the data. Additionally, the system may allow the application in limited production (with just a few users allowed access, such as less than 5 users), and allow the application to only be used for inquiry (no new data or modifications). Additionally, and upon meeting the retain period and the retention requirements identified, the system may teardown and decommission the application at the end of the retain period.

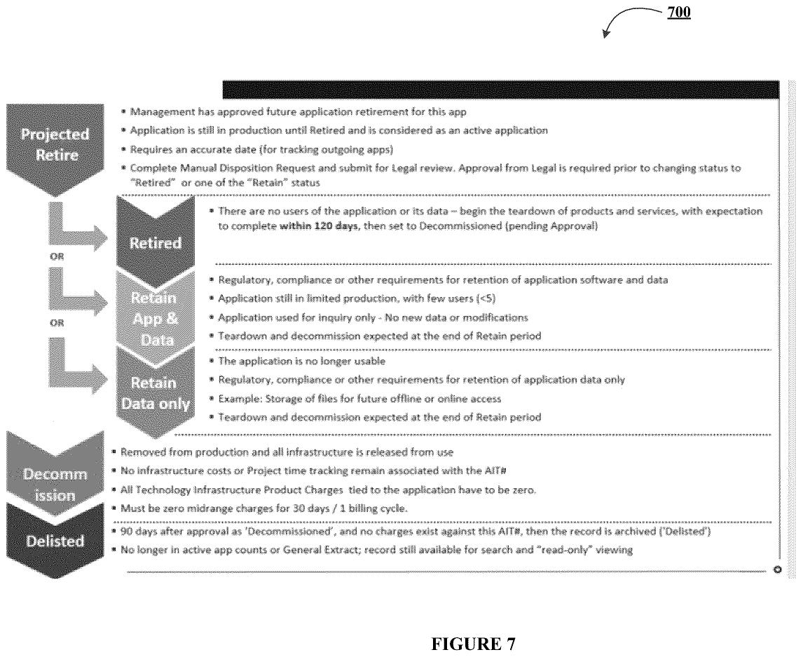

FIG. 7 illustrates a process 700 for decommissioning applications in an electronic environment, in accordance with an embodiment of the disclosure. In some embodiments, a system (e.g., similar to one or more of the systems described herein with respect to FIGS. 1A-1C) may perform one or more of the steps of process 700. For example, a system (e.g., the system 130 described herein with respect to FIG. 1A-1C) may perform the steps of process 700.

For example, and as shown in process 700, an application may start in a projected retire status, and then based on receiving an application decommission indicator(s), the system may update the projected retire status to at least one of a retired status, a retain application and data status, a retire and retain data only request, and/or the like. Further, and based on each of these status, the system may update an application decommission interface component with the decommission requirement indicators which may change based on each application decommission indicator (e.g., a retired status may require the application to not have any current users or that the current usage data is zero). Additionally, and upon determining that each of the application decommission requirements have been met, the system may decommission the application, which may refer to the removal of the application form production and all infrastructure is released from use, no infrastructure costs or project time tracking remain associated with the application identifier, all technology infrastructure product costs tied to the application are zero, and a billing cycle for the application is zero for 30 days or one billing cycle. Additionally, and upon decommissioning the application, the system may delist the application, which may comprise archiving the record for the application (e.g., the application data that may have been retained, storing the data for inquiry only, and/or the like).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for decommissioning applications in an electronic environment, the system comprising:
a memory device with computer-readable program code stored thereon;
at least one processing device operatively coupled to the at least one memory device and the at least one communication device, wherein executing the computer-readable code is configured to cause the at least one processing device to:
identify an application identifier associated with an application in a network environment;
collect, from an application repository, current application data associated with the application identifier;
generate, based on the current application data, an application decommission interface component;
configure a graphical user interface of a user device with the application decommission interface component, wherein the user device is associated with the application;
collect, from the user device associated with the application, an application decommission indicator, wherein the application decommission indicator comprises a decommission date for the application;
update the application decommission interface component and the graphical user interface configured with the updated application decommission interface component based on the application decommission indicator, wherein the updated application decommission interface component comprises a plurality of decommission requirement indicators; and
decommission, in an instance where each of the plurality of decommission requirement indicators have been met, the application in the network environment based on the application decommission indicator and the current application data.

2. The system of claim 1, wherein a decommission status for the application is updated in response to the identification of the application identifier, and wherein the updated decommission status comprises a projected decommission indicator for the application identifier.

3. The system of claim 1, wherein executing the computer-readable code is further configured to cause the at least one processing device to:
transmit a decommission request to the user device associated with the application;
receive, in response to the transmission of the decommission request, an approval of the decommission request; and
update, in response to the approval, the application decommission indicator.

4. The system of claim 1, wherein the application decommission indicator comprises at least one of a retire request or a retire and retain data only request.

5. The system of claim 4, wherein the current application data comprises at least one of current usage data and the application decommission indicator comprises the retire request, and wherein executing the computer-readable code is further configured to cause the at least one processing device to:
determine, based on the current application data, the current usage data comprises a zero usage indicator for the at least one application;
determine, based on the updated application decommission interface component, the application has met each decommission requirement of the application decommission interface component; and
decommission, in an instance where each of the plurality of decommission requirement indicators have been met, the application in the network environment based on the application decommission indicator and the current application data.

6. The system of claim 5, wherein the determination of the current usage data is continuously determined until the current usage data comprises the zero usage indicator.

7. The system of claim 4, wherein the application decommission indicator comprises the retire and retain data only request, and wherein executing the computer-readable code is further configured to cause the at least one processing device to:
determine, based on the current application data, the current usage data comprises a zero usage indicator for the at least one application;
determine, based on the application, at least one retention requirement of application data from the application;
automatically store at least a portion of the application data based on the at least one retention requirement; and
decommission, in response to the at least one retention requirement being met by the automatic storage of at least the portion of the application data, the application.

8. The system of claim 1, wherein the application decommission indicator comprises a retain application and data request.

9. The system of claim 8, wherein executing the computer-readable code is further configured to cause the at least one processing device to:
identify a retain period for the application;
determine, based on the application, at least one retention requirement of application data from the application;
identify, based on the at least one retention requirement, at least one user identifier that is allowed access to the application at a future time after the decommission of the application, wherein the decommission of the application is a partial decommission;
configure the application for inquiry only; and
decommission, in response to the retain period being met, the configured application.

10. The system of claim 1, wherein the decommission of the application comprises a predefined decommission period between the collection of the application decommission indicator and the decommission of the application.

11. The system of claim 1, wherein the application repository comprises a plurality of application data sources.

12. The system of claim 11, wherein the application decommission interface component and the updated application decommission interface component comprises a plurality of hyperlinks to the plurality of application data sources.

13. The system of claim 1, wherein the decommission of the application comprises a full or partial decommission.

14. A computer program product for decommissioning applications in an electronic environment, wherein the computer program product comprises at least one non-transitory computer-readable medium having computer-readable program code portions embodied therein, the computer-readable program code portions which when executed by a processing device are configured to cause the processor to:
identify an application identifier associated with an application in a network environment;
collect, from an application repository, current application data associated with the application identifier;
generate, based on the current application data, an application decommission interface component;
configure a graphical user interface of a user device with the application decommission interface component, wherein the user device is associated with the application;
collect, from the user device associated with the application, an application decommission indicator, wherein the application decommission indicator comprises a decommission date for the application;
update the application decommission interface component and the graphical user interface configured with the updated application decommission interface component based on the application decommission indicator, wherein the updated application decommission interface component comprises a plurality of decommission requirement indicators; and
decommission, in an instance where each of the plurality of decommission requirement indicators have been met, the application in the network environment based on the application decommission indicator and the current application data.

15. The computer program product of claim 14, wherein the application decommission indicator comprises at least one of a retire request or a retire and retain data only request.

16. The computer program product of claim 14, wherein the current application data comprises at least one of current usage data and the application decommission indicator comprises the retire request, and wherein the processing device is configured to cause the processor to:
determine, based on the current application data, the current usage data comprises a zero usage indicator for the at least one application;
determine, based on the updated application decommission interface component, the application has met each decommission requirement of the application decommission interface component; and
decommission, in an instance where each of the plurality of decommission requirement indicators have been met, the application in the network environment based on the application decommission indicator and the current application data.

17. The computer program product of claim 14, wherein the application decommission indicator comprises the retire and retain data only request, and wherein the processing device is configured to cause the processor to:
determine, based on the current application data, the current usage data comprises a zero usage indicator for the at least one application;
determine, based on the application, at least one retention requirement of application data from the application;
automatically store at least a portion of the application data based on the at least one retention requirement and the retain period; and
decommission, in response to the retain period being met and the at least one retention requirement being met by the automatic storage of at least the portion of the application data, the application.

18. A computer implemented method for decommissioning applications in an electronic environment, the computer implemented method comprising:
identifying an application identifier associated with an application in a network environment;
collecting, from an application repository, current application data associated with the application identifier;
generating, based on the current application data, an application decommission interface component;
configuring a graphical user interface of a user device with the application decommission interface component, wherein the user device is associated with the application;
collecting, from the user device associated with the application, an application decommission indicator, wherein the application decommission indicator comprises a decommission date for the application;
updating the application decommission interface component and the graphical user interface configured with the updated application decommission interface component based on the application decommission indicator, wherein the updated application decommission interface component comprises a plurality of decommission requirement indicators; and
decommissioning, in an instance where each of the plurality of decommission requirement indicators have been met, the application in the network environment based on the application decommission indicator and the current application data.

19. The computer implemented method of claim 18, wherein the application decommission indicator comprises at least one of a retire request or a retire and retain data only request.

20. The computer implemented method of claim 19, wherein the current application data comprises at least one of current usage data and the application decommission indicator comprises the retire request,
determining, based on the current application data, the current usage data comprises a zero usage indicator for the at least one application;
determining, based on the updated application decommission interface component, the application has met each decommission requirement of the application decommission interface component; and
decommissioning, in an instance where each of the plurality of decommission requirement indicators have been met, the application in the network environment based on the application decommission indicator and the current application data.
